(19) United States
(12) Patent Application Publication
(10) Pub. No.: US 2007/0110884 A1
(43) Pub. Date: May 17, 2007

(54) Additive for meat product, meat product and method for making same

(76) Inventor: Gregory John Kay, Queensland (AU)

Correspondence Address: Joseph T. Leone;DeWitt Ross & Stevens S.C., 8000 Excelsior Drive, Madison, WI, 53717, US

(21) Appl. No.: 11/280,913

(22) Filed: Nov. 16, 2005

(51) Int. Cl. A23L 1/31

(52) U.S. Cl. 426/645

(57) ABSTRACT

A process of treating a slab of steak is disclosed. The process comprises cleaning the steak and then placing the steak in a tenderiser to tenderise the steak. The process then includes pumping a meat additive into the slab of steak. The meat additive comprises sodium alginate; at least one of sodium lactate, sodium citrate and citric acid; and water and optionally also slats and vegetable protein. Thereafter the slab of steak is placed into a vacuum massager and massaged for a period of time. An amount of hydrolysed calcium sulphate and/or carrageenan is added to the slab of steak before or after said vacuum massaging step. The next step involves forcing the meat through an orifice and into a meat casing having at least one open end to form a cased meat product. Thereafter any open ends of the meat casing are closed. The cased meat product is then stored at a temperature of 1° C. to 10° C. for at least 12 hours to allow the steak and the additive pumped into it to set. The cased meat product is then frozen to crisp and harden it. It is then sliced using a slicer, to yield a plurality of slices of steaks. In one form the slab of meat is a rump. And the steak slices are used as steak patties in steak burgers. The process enables a substantially reproducible size and shape of steak slice to be obtained.

### FIELD OF THE INVENTION

This invention relates to an additive for a meat product. It also extends to a meat product to which the additive is added and a process for making a meat product. Finally the invention also extends to a meat product produced by the methods described above.

This invention relates particularly but not exclusively to a method of treating a piece of meat that is a slab of rump steak to yield slices of steak suitable for use as patties for steak burgers. Specifically the slices of rump steak are sized and shaped to be suitable for use on a round hamburger bun. It will therefore be convenient to hereinafter describe the invention with reference to this example application. However at the same time it is to be clearly understood that the invention is capable of broader application. For example the invention might be applied to meat products other than steak and steaks other than rump. The invention might also be used for yielding slices of meat other than those used to form steak burger patties. Very often the invention will be applied to a slab of meat that is cut from a carcass as distinct from a processed or manufactured meat that is formed in a roll shape such as salami.

### BACKGROUND TO THE INVENTION

Hamburgers are well known. They are made and eaten in large quantities in a number of countries around the world. Hamburgers are usually made from meat patties. The patties in turn are made from mince meat which is mixed up with a binder and then formed into the shape of a round meat patty. The patty has a flattened circular shape with two major surfaces.

An advantage of using a meat patty made of mince meat is that the patty can be made to a standard size in a reproducible fashion. All patties look the same and have the same size and shape. Further provided that the quality of the mince meat that is used is controlled, the taste and feel of the patty will also be the same.

The ability to produce a patty of reproducible feel and quality is particularly important for fast food companies operating franchise outlets. It is particularly important that the food product they offer is the same wherever it is served.

A variation on a hamburger with a meat patty is a steak burger. This comprises selecting a strip of steak broadly shaped and sized to cover a round hamburger roll, cooking it, and then placing it in the roll with salad and sauce and then serving the steak burger. These burgers are attractive to consumers of fast food and potentially there is a large market for this product.

However currently a problem exists that it is that it is hard to produce a steak with the same size, look and feel each time a steak burger is made. There can be variations in shape and variations in thickness. In addition there can be variations in the quality of the meat. These problems are well recognised by fast food operators and make a steak burger unattractive from a fast food operator's point of view.

Another problem with steak is the cost. The cost of steak is substantially higher than say that for a hamburger patty and thus the burger product will cost more. Further the cost of meat can fluctuate substantially over a short time and this can make it difficult to price products in a large chain with multiple outlets.

However fast food operators recognise the potential that a new product line in the form of a steak burger product would offer to their business. Clearly therefore it would be advantageous if a steak product could be devised that was of reproducible size and shape and thickness. It would also be advantageous if this product could be provided with a fairly even quality. Yet further it would be advantageous if a way could be found of treating an inexpensive piece of steak to improve its quality and thereby bring down the cost of the steak product.

### SUMMARY OF THE INVENTION

According to one aspect of this invention there is provided an additive for meat or a meat product comprising:
alginate;
at least one of sodium lactate, sodium citrate and citric acid; and
water.

In one embodiment, the additive comprises sodium citrate and citric acid. In another embodiment, the additive comprises sodium lactate. The additive may comprise sodium lactate, sodium citrate and citric acid. Advantageously the additive comprises a blend of all three components above although the relative amounts of each can vary. Typically, the alginate is sodium alginate, such as protanal, e.g. protanal RF 6650 or protanal LF 200.

The amounts of sodium lactate, sodium citrate and citric acid typically range from 0.1 wt % to 10 wt % for each component, such as from 0.5 wt % to 5 wt %.

The additive may further include one or more mineral salts. The additive may also include a salt which is sodium chloride, e.g. table salt. The amount of salt typically ranges from 0.05 wt % to 15 wt %, such as from 0.1 wt % to 10 wt %.

The additive may also include hydrolysed vegetable protein. The amount of hydrolysed vegetable protein typically ranges from 0.05 wt % to 15 wt %, such as from 0.1 wt % to 10 wt %.

The sodium lactate, sodium citrate and citric acid help to tenderise the meat and also assists in prolonging the shelf life of the meat product.

The sodium alginate encourages water retention in the meat product. The salt and mineral salts also encourage water retention in the meat product and assist with tenderising the meat.

The vegetable protein promotes flavour in the meat product.

According to another aspect of this invention there is provided a method of treating meat comprising introducing an additive comprising sodium alginate, at least one of sodium lactate, sodium citrate and citric acid, and water into meat or a meat product.

The sodium alginate may be protanal. The at least one of sodium lactate, sodium citrate and citric acid may be a combination of all three.

The additive may include any one or more of the optional features of the additive described above according to the first aspect of the invention.

Further the additive may be introduced into the interior of the meat. The additive may be injected or pumped into the meat using a multi point injector, e.g. a pickle injector.

The amount of additive which is pumped into the meat may have a weight that is 20-50% of the weight of the meat. The amount of additive may be 30 to 40% of the weight of the meat, e.g. 33-38% of the weight of the meat.

The additive may be introduced into a slab of meat that has been cut from a carcass before the slab of meat is cut up into smaller pieces such as slices of steak.

According to another aspect of this invention there is provided a process of treating meat comprising:
providing a slab of meat; and
forcing the slab of meat through a formation defining a restricted opening and into a meat casing such that it is received within the meat casing forming a cased meat product.

The process may further include the initial step of cutting the slab of meat broadly into a shape which can be forced through the restricted opening and into the casing.

The meat may be obtained directly from a carcass, e.g. being cut from a carcass, and not be processed or manufactured meat.

The process may also include cleaning the slab of meat before it is passed through the restricted opening. The step of cleaning the slab may include taking the fat and gristle off. The step of cleaning may also include taking the cap and tail off. The cap and tail, i.e. the ends of the slab, are not used. The cap and tail may be taken off before the gristle and fat are taken off.

The process may also include tenderising the meat in a tenderiser, e.g. after it has been cleaned and before it is forced through the restricted opening. The meat may be tenderised in a ROSS tenderiser.

The process may also include introducing a meat additive into the slab of meat before it is forced through the restricted opening. The meat additive may include any one or more of the features of the additive described in the first aspect of the invention above. For example, the meat additive may include sodium alginate, sodium lactate, sodium citrate, citric acid and water. The additive may be pumped into the slab of meat using a multi point injector or a pickle injector.

The amount of additive that is pumped into the slab of meat may have a weight corresponding to 20-50% of the weight of the slab of meat. The amount of additive may be 30 to 40% of the weight of the meat.

The process may further include vacuum massaging the slab of meat before it is forced through the restricted opening. The process may also include adding calcium sulphate and/or carrageenan to the slab of meat. The calcium sulphate and/or carrageenan may be added either before, after or while the slab is being subjected to said vacuum massaging.

In one form of the invention the slab of meat is subjected to a first step of vacuum massaging, then adding said calcium sulphate and carrageenan, and then subjecting the slab of meat to a second step of vacuum massaging. Further said first step of vacuum massaging may last 10 to 30 minutes, e.g. 15 to 25 minutes, and the second step of vacuum massaging may last 5 to 15 minutes, e.g. 8 to 12 minutes.

The calcium sulphate may be added to the meat in an amount of 0.1 g to 10 g of calcium sulphate per 100 g of the slab of meat. Preferably the amount of calcium sulphate is 0.5% to 5% of calcium sulphate, more preferably 0.8% to 1.2%.

The carrageenan may be added to the meat product at the same time that the calcium sulphate is added.

The carrageenan may also be added to the meat in an amount of 0.1 g to 1 g of gum per 100 g of the slab of meat, i.e. 0.1 to 1.0%. Preferably the amount of gum is 0.1% to 0.7% of the weight of the slab of meat, more preferably about 0.4%.

The restricted opening may be formed by an extrusion die and the slab of meat may be extruded through the extrusion die using an air ram. The die may be in the form of a nozzle, e.g. an extrusion nozzle or an orifice opening having a substantially circular shape.

The casing may be fibrous and as such is porous to air and water. The casing may have a size of 110 mm to 130 mm in diameter. The casing may have a diameter of 110 mm to conform to the diameter of a hamburger bun and the cased meat product may also therefore have a diameter of about 110 mm to correspond to the typical diameter of a hamburger bun.

At least one end of the casing may be open. Sometimes both ends of the casing will be open. The method may include closing off the open ends of the meat casing. The ends of the casing may be closed off using clips.

After the slab of meat has been inserted into the casing, the cased meat product may be kept at a temperature of 1° C. to 3° C. for at least 12 hours while it is being left to set. The cased meat product may be left to set for at least 16 hours, e.g. about 20-25 hours.

After the meat product has set, it may be placed in a freezer which causes the meat to freeze wherein to make the meat crisp and hard and suitable for being crisply cut into slices.

The process may include the yet further step of slicing the cased meat product, which is frozen to make it hard, into a plurality of slices of the meat. Each slice that is sliced off may have a weight of 90 g to 100 g, e.g. about 100 g.

The method may include the final step of removing the pieces of casing from the cut slices.

The process may further include placing dividers between adjacent said slices to resist the slices from sticking together and then packing a batch of slices of meat into a package for distribution.

The step of packing a batch of slices may comprise stacking a plurality of said slices one on top of each other in a box with the dividers between adjacent slices to resist them sticking together.

In a preferred form each said package has about 50 said slices, e.g. 48 slices. Once packaged the slices may be stored in a frozen condition.

The meat may be a steak such as rump, sirloin, porterhouse or a fillet such as a rib fillet. Preferably the meat is a rump steak or a rib fillet. The slices of steak may be sized to correspond with the size of a round bread bun so that they are suitable for use as steak patty on a steak burger.

Applicant has found that a slab of meat treated in this way enjoys a high level of liquid retention in the meat, e.g. during cooking. This increases the weight and thereby the value of the meat.

According to another aspect of this invention there is provided a process of treating a slab of steak comprising:
cleaning the slab of steak;
placing the steak in a tenderiser and then tenderising the steak;
pumping a meat additive according to the first aspect of the invention described above into the slab of steak;
placing the slab of steak into a vacuum massager and massaging the slab of steak;
adding an amount of hydrolysed calcium sulphate and/or carrageenan to the slab of steak before or after said vacuum massaging step;
forcing the meat through an orifice and into a meat casing having at least one open end to form a cased meat product;
storing the cased meat product at a temperature of 1° C. to 10° C. for at least 16 hours to allow the steak and the additive pumped into it to set;
freezing the cased meat product to crisp and harden it for slicing; and
slicing the meat product, using a slicer, to yield a plurality of slices of steak.

The slab of meat may be a rump or rib fillet which is a particular cut of beef from a carcass. The rump steak is cut from the rump region of the carcass.

The process may further include closing the open end of the meat casing.

By cleaning the slab is meant removing the cap and tail and then removing fat and gristle.

The slices of meat may be used as steak slices or steak patties in steak burgers.

The slices may be packaged for distribution and then distributed to makers and suppliers of steak burgers. In particular the packages of steak slices may be supplied to fast food outlets including those that make hamburgers. These may include franchise fast food outlets such as Burger King and McDonalds.

According to yet another aspect of this invention there is provided a method for making a steak burger comprising:
providing at least one steak slice made in accordance with the process described in the third or further aspects of the invention described above;
cooking the steak slice using a cooking contrivance;
slicing a bread bun to yield upper and lower bun portions; and
placing the cooked piece of steak on the bread bun such that is sandwiched between sliced portions of the bread bun.

According to yet another aspect of this invention there is provided a steak burger comprising a piece of steak made by the process described in any one of the third or fourth aspects of the invention described above and then cooked; and a round bread bun that has been sliced in the usual way to yield upper and lower portions, and wherein the cooked piece of steak is sandwiched between upper and lower portions of the bun.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

### BRIEF DESCRIPTION OF THE DRAWINGS

FIG. 1 is a schematic flow sheet of the process used to treat a slab of meat;

FIG. 2 is a three dimensional view of a multi point needle injector above the slab of meat;

FIG. 3 is a schematic three dimensional view of the apparatus used to case the meat in the process in FIG. 1;

FIG. 4 is a front view of the cased meat product produced by the apparatus shown in FIG. 3;

FIG. 5 is a three dimensional view of the cased meat product being sliced into slices; and

FIG. 6 is a three dimensional view of a slice of the meat after the casing has been removed; and

FIG. 7 is a three dimensional view of the slice of FIG. 6 mounted on the lower portion of a hamburger bun (the upper portion being omitted for clarity) where it forms a steak burger.

### DETAILED DESCRIPTION OF THE PREFERRED EMBODIMENTS

An additive for meat and a process for treating meat in accordance with this invention may manifest itself in a variety of forms. It will be convenient to hereinafter provide a detailed description of at least one embodiment of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

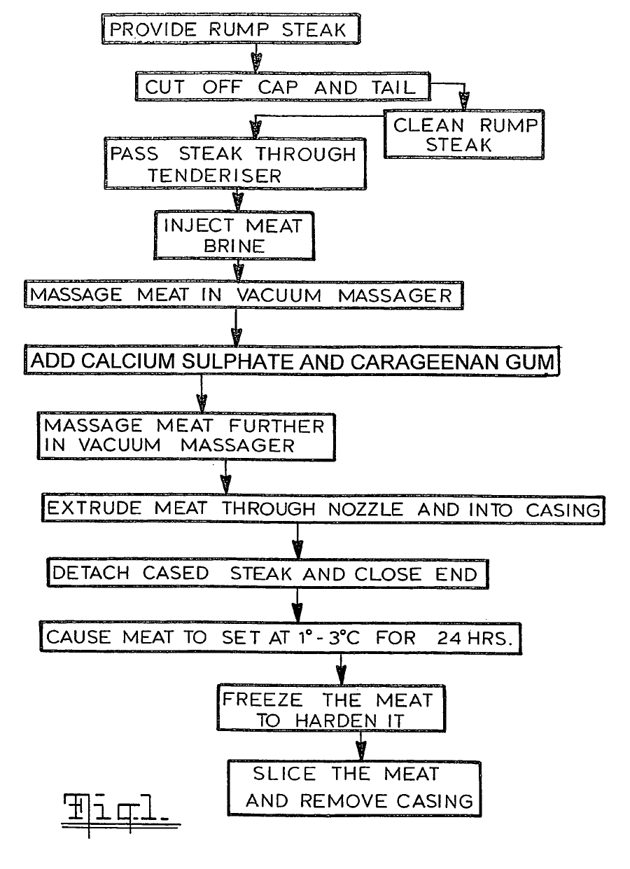

FIG. 1 is a schematic block diagram showing the different steps carried out in the method of treatment in accordance with the invention.

The method is commenced by taking a slab of meat such as a rump that is to be treated and cleaning the slab of meat. This involves removing the cap and tail and discarding these and then removing the fat and gristle on the slab.

Rump is chosen because it is a steak of reasonable quality that can be obtained at a reasonably inexpensive price. Further it can be treated as will be described below to improve its quality. A rib fillet and a sirloin can also be chosen.

The slab of rump steak is then passed through a tenderiser. The tenderiser has a plurality of sharp points that cut through the sinew in the meat at regular spaced intervals. By cutting through the sinew at these points the meat can be broken up more easily when it is chewed by the user and is perceived by the user as being more tender.

In the illustrated version the meat is tenderised in a ROSS tenderiser which is a piece of equipment that is well known in the art. As the structure and function of ROSS tenderisers would be well known in the art and they do not form part of the invention here they will not be described in further detail in the specification.

After the meat has been tenderised in the tenderiser an additive in the form of a liquid is pumped into the interior of the slab of meat.

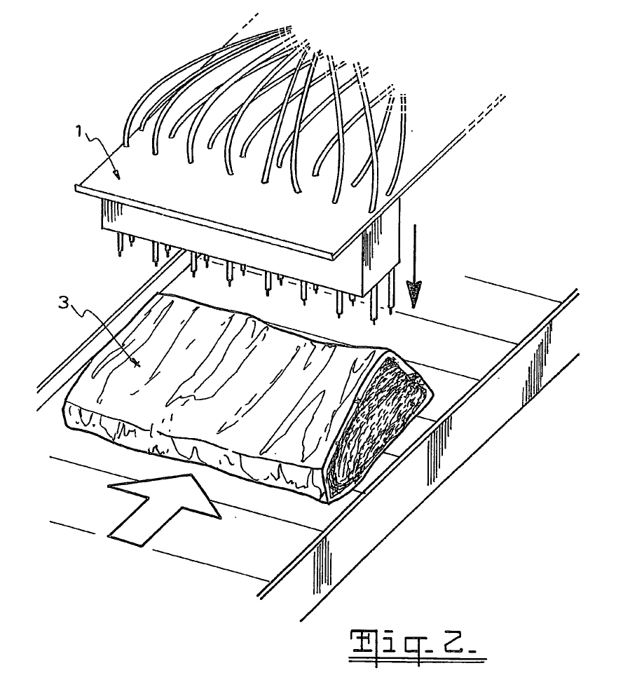

FIG. 2 shows a multi point injector that is a pickle injector that is used to inject the liquid additive into the slab of meat 3. The injector 1 has about 30 needles that are arranged in the form of a substantially planar array spaced apart from each other that are inserted into the slab of meat 3. Once the needles have been inserted the liquid additive is injected into the body of the meat through the points of the needles.

The additive comprises the following components:
Mineral salts
Salt
Florex (hydrolysed vegetable protein)
Tomax (blend of sodium lactate, sodium citrate, and citric acid)
Sodium alginate protanal RF 6650
Water

In the embodiment of additive used in the Applicant's test work the following amounts of the various components were present:
21.8 wt % Mineral salts
32.6 wt % Salt
13.0 wt % Florex (hydrolysed vegetable protein)
21.8 wt % Tomax (blend of sodium lactate, sodium citrate and citric acid)
10.9 wt % Sodium alginate protanal RF 6650
This is then diluted in water on an approximate 1:1 basis and then pumped into the slab of meat.

The amount of liquid additive injected into the slab of meat had a weight corresponding to about 35% by weight of the slab of meat. For example if the slab of meat weighs 2 kg then about 700 ml of liquid additive weighing about 700 g will be pumped into the slab of meat.

For one such additive used by the Applicant the following quantities of the various components were used:
1 kg Mineral salts
1.5 kg Salt
0.600 kg Florex (hydrolysed vegetable protein)
1 l (about 1 kg) Tomax (blend of sodium lactate, sodium citrate, and citric acid)
½ l Sodium alginate protanal RF 6650
50 L (50 kg) Water.

This yields a slab of rump that has increased mass due to the liquid additive that has been pumped into it. After this the slab of rump is placed into a vacuum massager and massaged for about 20 minutes at full vacuum in a first vacuum massaging step. The vacuum massager softens the meat and makes it more formable and malleable. Vacuum massagers are standard pieces of equipment in the butchery industry and would be well known to persons skilled in the art. Accordingly they will not be described in further detail in the specification.

After the first vacuum massaging step has been completed the massager is opened up and hydrolysed calcium sulphate and carrageenan are both added to the slab of meat. The calcium sulphate is added in an amount of 1% by weight of the slab of meat. Thus if the meat is 2 kg then 20 g of sulphate will be added to the massager. The carrageenan is added in an amount corresponding to 0.4% by weight of the meat. Thus if the meat is 2 kg then 8 g of gum will be added. These additives have a beneficial effect on the processing of the meat.

The slab of rump is then massaged for about a further 10 minutes at full vacuum in a second vacuum massaging step.

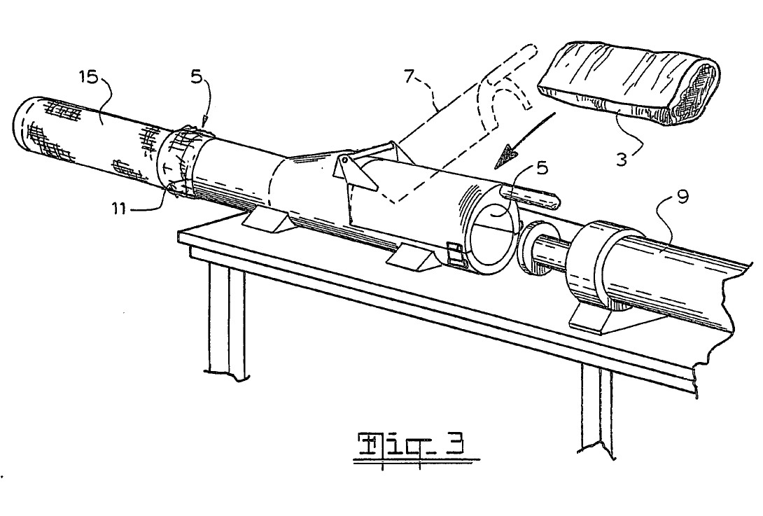

After the massaging steps are complete the next step is to pass the slab of rump through an extrusion apparatus and into a casing using the extrusion apparatus shown in FIG. 3. Broadly it comprises an extrusion die 4 including an extrusion orifice or nozzle 11. It also includes a loading compartment 5 and a lid 7 over the loading compartment 5 upstream of the extrusion orifice 11. It also includes an air ram 9 upstream of the extrusion orifice 11 for urging the slab of meat 3 through the orifice 11 and into a casing 15.

The slab of rump 3 is placed in the loading compartment 5 and then the lid 7 is closed. The walls of the compartment 5 and the lid 7 when closed tend to force the slab of meat 3 into the shape of the compartment 5 which is broadly in the form of a circular cylinder. This is broadly the same shape as the casing 15 when it is expanded. Thereafter the air ram 9 is activated applying a force to the rear end of the slab of meat 3 and forcing it through the extrusion orifice 11.

The fibrous casing 15 which has a diameter of 100 mm to 130 mm is mounted on a downstream end of the orifice 11. Thus when the slab of meat 3 is forced through the orifice 11 it enters the casing 15. When the slab of meat 3 has been pushed through the orifice 11 it is fully received in the casing 15. The casing 15 is then manually detached from the orifice 11.

The casing 15 has ends 17, 18 that are open when it is detached from the orifice 11. The open ends 17, 18 are closed off by clips or by tying the ends 17, 18. As shown in FIG. 4 the cased meat product 20 contains a slab of steak that has a broadly circular cylindrical shape.

The next step in the process involves causing the slab of meat within the casing to set. This is done by cooling the cased meat product 20 to 1° C. to 3° C. for about 24 hours. This has the effect of causing gelatinous components within both the additive and the meat to set. Once the cased meat product has been set, the meat as a whole has a far greater gelatinous consistency.

Once the slab of meat within the cased meat product 20 has been set it needs to be frozen to firm and harden it up for slicing. The freezing of the slab of meat within the casing enables the slab 20 to be crisply and cleanly sliced. The slab is frozen by placing it in a freezer.

The cased slab is then sliced in a ROSS meat slicer. Again a slicer would be well known piece of equipment in the butchery business and it would be well known to persons skilled in the art. Accordingly it will not be described in further detail in the specification.

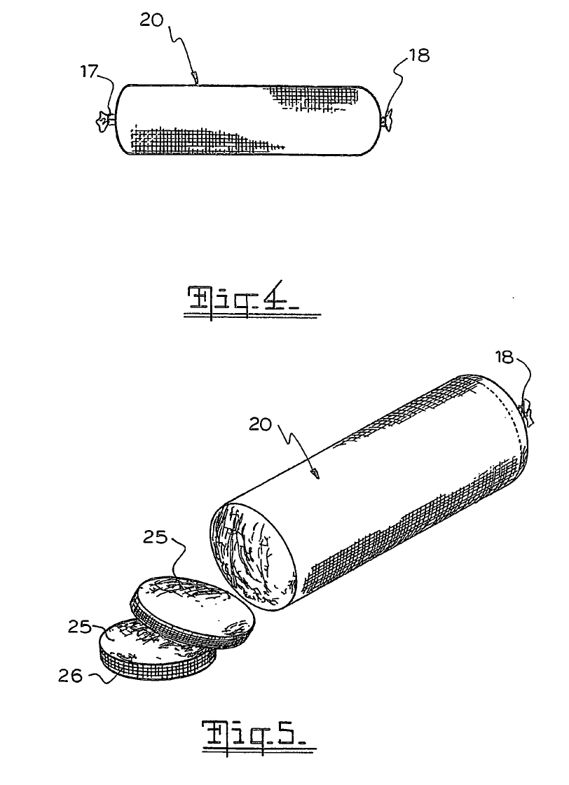

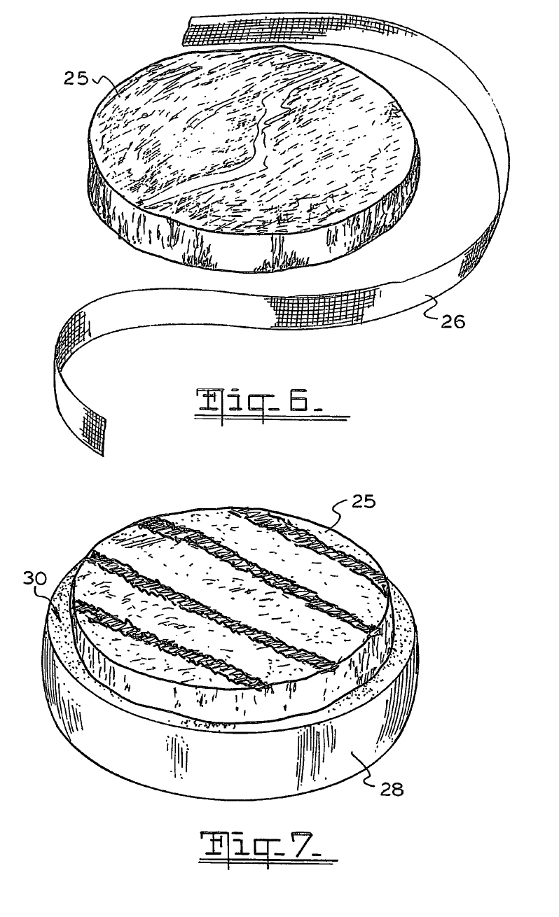

As shown in FIG. 5 the cased product 20 is sliced into thin and even slices of meat 25. The shape of the slices 25 is shown in FIGS. 3 and 4. In the illustrated version each slice 25 has a thickness of about 9 mm. After each slice 25 has been cut the band of casing material 26 around the circumference of the slice 25 can be manually removed. The casing 26 is simply pulled off the slice 25 as shown in FIG. 6.

The steak slices produced by this method have a uniform size and shape and also a fairly uniform weight. Each slice has a diameter of about 110 mm, a thickness of about 9 mm, and a weight of about 100 g. Its dimensions are thus similar to those of a hamburger patty and Applicant believes that it will be particularly well suited to serve as a steak slice or steak patty for a steak burger.

After being sliced into slices, the slices of steak are packed into packaging boxes for sale and distribution. Typically a number of slices 25 may be stacked on top of each other in a stack. Separators or dividers may be placed in between adjacent slices to resist them from sticking to each other. After the slices 25 have been packed into boxes they are frozen and they are distributed and stored in a frozen condition.

The end user typically might be a food provider serving hamburgers. When the user makes steak burgers individual slices will be taken out of the packaging and then cooked in the usual way. This might be by grilling, convection heating or by frying the slices. Thereafter they are placed on a sliced hamburger bun between upper and lower portions of the bun to form a steak burger. A steak burger is shown in FIG. 7. The steak burger may further include salad such as lettuce, tomato and beetroot on the bun. It may also include cheese, egg, bacon and also sauce.

By processing the slab of rump in this way Applicant is able to produce a very reproducible size and shape of steak patty. The variations in diameter, thickness and weight are minimal. By virtue of the reproducibility of the size and shape of the steak slice Applicant believes that it will find particular application with fast food operators selling hamburgers and the like.

In another embodiment of the invention that has not been shown a slab of meat is used that is a sirloin or a rib fillet. These pieces of meat are then treated in the same way as the rump steak described above to produce the slices of steak that are used for steak burgers.

In yet another embodiment of the invention the meat be it rump steak, rib fillet or sirloin is forced in to the casing and then caused to set. After this it is diced into diced pieces of meat or cut into slices. These slices are then frozen and packed for distribution. The diced meat may be used for meals such as beef stroganoff.

Further the method described above has produced increased water retention in the meat during cooking and the like and thus adds to the final weight of the meat product. This will increase the selling price of the meat. The increases in weight that the Applicant has obtained have been substantial.

Further various steps in the processing used by the method are able to tenderise and improve the quality of the meat product. For example a cut such as rump steak can be treated to make it softer and more attractive to eat. This opens up the possibility of fast food operators being able to use this meat for a steak burger as a viable option to a mince patty hamburger and at a competitive price.

It will of course be realised that the above has been given only by way of illustrative example of the invention and that all such modifications and variations thereto as would be apparent to persons skilled in the art are deemed to fall within the broad scope and ambit of the invention as herein set forth.

We claim:

1. A process of treating meat comprising:
providing a slab of meat; and
forcing the slab of meat through a formation defining a restricted opening and into a meat casing such that it is received within the meat casing forming a cased meat product.

2. A process of treating meat according to claim 1, further including the initial step of cuffing the slab of meat broadly into a shape which can be forced through the restricted opening and into the casing.

3. A process of treating meat according to claim 1, further including cleaning the slab of meat before it is passed through the restricted opening, and also tenderising the meat in a tenderiser before it is forced through the restricted opening.

4. A process of treating meat according to claim 1, further including introducing a meat additive into the slab of meat before it is forced through the restricted opening.

5. A process of treating meat according to claim 4, wherein the meat additive includes sodium alginate; at least one of sodium lactate, sodium citrate and citric acid; and water.

6. A process of treating meat according to claim 4, wherein the meat additive comprises sodium lactate, sodium citrate and citric acid, and wherein the additive is pumped into the slab of meat using a multi point injector or a pickle injector.

7. A process of treating meat according to claim 4, wherein the amount of additive that is pumped into the slab of meat has a weight corresponding to 20-50% of the weight of the slab of meat.

8. A process of treating meat according to claim 1, further including vacuum massaging the slab of meat before it is forced through the restricted opening.

9. A process of treating meat according to claim 8, further including adding calcium sulphate and/or carrageenan to the slab of meat either before, after or while the slab is being subjected to vacuum massaging.

10. A process of treating meat according to claim 9, comprising subjecting the slab of meat to a first step of vacuum massaging, then adding said calcium sulphate and/or carrageenan, and then subjecting the slab of meat to a second step of vacuum massaging.

11. A process of treating meat according to claim 10, wherein said first step of vacuum massaging lasts 10 to 30 minutes and the second step of vacuum massaging lasts 5 to 15 minutes.

12. A process of treating meat according to claim 9, wherein calcium sulphate is added to the meat in an amount of 0.1 g to 10 g of calcium sulphate per 100 g of the slab of meat, and the carrageenan is added to the meat in an amount of 0.1 g to 1 g of gum per 100 g of the slab of meat.

13. A process of treating meat according to claim 1, wherein the casing is fibrous and as such is porous to air and water and the casing has a size of 110 mm to 130 mm in diameter.

14. A process of treating meat according to claim 1, wherein after the slab of meat has been inserted into the casing, the cased meat product is kept at a temperature of 1° C. to 3° C. for at least 16 hours while it is being left to set.

15. A process of treating a meat product according to claim 14, wherein after the cased meat product has been set, it is placed in a freezer which causes the meat to freeze wherein to make the meat crisp and hard and suitable for being crisply cut into slices.

16. A process according to claim 15, further including slicing the cased meat product into a plurality of slices of the meat after it has been frozen.

17. A process of treating a meat product according to claim 16, further including placing dividers between adjacent said slices of meat to resist the slices from sticking together and then packing a batch of said slices of meat into a package for distribution.

18. A process of treating a meat product according to claim 1, wherein the meat product is a steak such as rump, sirloin, porterhouse or fillet such as rib fillet.

19. A process of treating a meat product according to claim 18, wherein the slices are slices of steak that are sized to correspond with the size of a round bread bun so that they are suitable for use as steak patty on a steak burger.

20. A process of treating a slab of steak comprising:
cleaning the steak;
placing the steak in a tenderiser and then tenderising the steak;
pumping a meat additive comprising sodium alginate; at least one of sodium lactate, sodium citrate and citric acid; and water into the slab of steak;
placing the slab of steak into a vacuum massager and massaging the slab of steak;
adding an amount of hydrolysed calcium sulphate and/or carrageenan to the slab of steak before or after said vacuum massaging step;
forcing the meat through an orifice and into a meat casing having at least one open end to form a cased meat product;
storing the cased meat product at a temperature of 1° C. to 10° C. for at least 16 hours to allow the steak and the additive pumped into it to set;
freezing the cased meat product to crisp and harden it for slicing; and
slicing the meat product, using a slicer, to yield a plurality of slices of steak.

21. A process according to claim 20, wherein the slices of meat are used as steak slices or steak patties in steak burgers.

22. A method for making a steak burger comprising:
providing at least one steak slice made in accordance with claim 1,
cooking the steak slice using a cooking contrivance;
slicing a bread bun; and
placing the cooked piece of steak on the bread bun such that is sandwiched between sliced portions of the bread bun.
